(19) United States
(12) Patent Application Publication
(10) Pub. No.: US 2010/0089671 A1
(43) Pub. Date: Apr. 15, 2010

(54) VEHICLE

(75) Inventor: Johann Trunkenpolz, Maria Schmolln (AT)

Correspondence Address: LAW OFFICE OF ROD D. BAKER, 707 STATE HIGHWAY 333, SUITE B, TIJERAS, NM, 87059-7382, US

(73) Assignee: KTM Sportmotorcycle AG, Mattighofen (AT)

(21) Appl. No.: 12/449,407

(22) PCT Filed: Jan. 22, 2008
(86) PCT No.: PCT/EP2008/000462

§ 371 Date: Aug. 6, 2009

(30) Foreign Application Priority Data
Feb. 7, 2007 (DE) 10 2007 006 167.8

(51) Int. Cl. B62M 23/02

(52) U.S. Cl. 180/65.23

(57) ABSTRACT

Proposed is a vehicle having at least one front wheel (2) drivable by means of an electric motor and at least one drivable rear wheel (3) as well as an internal combustion engine (4) supplying the front wheel (2) and rear wheel (3) with drive energy, the internal combustion engine (4) being coupled to a starter generator (16) for starting the internal combustion engine (4) and furnishing electrical drive energy for driving the front wheel (2).

The present invention relates to a vehicle having at least one front wheel drivable by means of an electric motor and at least one drivable rear wheel as well as an internal combustion engine supplying the front wheel and rear wheel with drive energy as set forth in the preamble of claim 1.

A generic vehicle has at least one front wheel which can be driven by an electric motor and also a rear wheel which can be driven either by the internal combustion engine directly or via a further electric motor, the drive energy for the front wheel and rear wheel being made available directly or indirectly via the internal combustion engine.

When the vehicle involved is a two-wheeler it may be a motorcycle in which both the front wheel and also the rear wheel is driven, the front wheel being actuated via an electric motor. A similar configuration is also possible on a vehicle having more than two wheels, however, for example, on an all terrain vehicle (ATV) or quad in which at least one front wheel and at least one rear wheel are driven.

A motorcycle having a two-wheel drive is known, for example, from EP 0 779 205 B1 This motorcycle has an internal combustion engine for driving the rear wheel and a so-called fluid motor, i.e. a hydraulic motor with which the front wheel of the known motorcycle can be driven. The front wheel drive can only be started when a pressure medium, for instance a hydraulic fluid, is pumped from the internal combustion engine via a pump pressurized in the fluid conduits to the front wheel of the motorcycle where it powers, for example, a vane wheel or axial piston motor or the like. In the known motorcycle as described above the fluid motor is engineered as a swashplate motor causing the front wheel to rotate. Supply and return of the pressurized oil needs to be assured via corresponding tubing between the body of the motorcycle and the front wheel structure, i.e. for example via a telescopic fork. However, the power communicatable by means of such a hydraulic drive is exceptionally low since the space available for accommodating the swashplate motor in the front wheel is severely restricted and, in addition to this, the swashplate motor needs to be configured light and small because of the otherwise significant increase in unsprung masses. This results in the power communicatable by such a drive being significantly limited at the front wheel, causing an early standstill of the front wheel drive when the front wheel comes up against an obstacle, for instance a bump in the terrain or some other irregularity in the road surface, since the available drive power of the front wheel is insufficient to overcome the obstacle.

Known from GB 2,265,568 A is a hybrid motorcycle featuring an internal combustion engine supplying the electric drive energy to both an electric motor for driving the front wheel as well as to an electric motor driving the rear wheel of this known motorcycle. Nothing reads from this patent, however, as to how the internal combustion engine furnishes the electric drive energy for the electric motors.

Known from US 2004/0134696 A1 is a motorcycle comprising an internal combustion engine and an electric motor in the front wheel. The electric motor in this arrangement also serves as a generator for recuperating the braking action. The electric motor of this known hybrid motorcycle in this arrangement may also be configured as a wheel hub motor.

Known, in conclusion, from DE 10 2004 010 230 A1 is a motorized two-wheeler, the rear wheel of which is connected to an internal combustion engine and the front wheel of which is connected to a electric motor which drives via a battery feed. In this arrangement the electric motor also serves for recuperation and the battery for operating the electric motor is charged via the dynamo of the motorcycle. This known motorcycle is a trial motorcycle for children and is intended to teach children how to safely negotiate terrain on a two-wheeler.

Also known, in conclusion, as it reads from the Korean patent abstract 10 2000 0023493 A is a motorcycle featuring a hybrid drive, comprising a stepless automatic gearing with which only one wheel of the vehicle is driven and in which the internal combustion engine has a starter generator.

Known from DE 1999 48 224 C1 is a two-wheeler comprising an internal combustion engine and electric wheel hub motors which are water-cooled.

Known from DE 10 2004 023 619 A1 is an electrical energy system in a hybrid vehicle featuring a crankshaft starter generator which can also function as an electric motor in boost operation to power the crankshaft of the internal combustion engine with added power. The electric motor in this arrangement can also be powered via a vehicle electric circuit with a battery rated at less than 60 V.

When a motorcycle fitted with an additional front wheel drive is employed, for example, as an off-road motorcycle, the electric motor must be capable of delivering a high torque to overcome, for example, rough terrain bumps, or to assist restarting a motorcycle or ATV having become bogged down in difficult terrain such as, for instance, sand or a swampy terrain. A hydraulic drive motor provided for this purpose would have to be dimensioned so large that it can no longer be integrated in the front wheel of a motorcycle or of an ATV. But even an electric motor directly driving the front wheel to make available a breakaway torque of more than 200 Newton meters at the front wheel would become too heavy to be incorporated in or on the front wheel of the motor vehicle or ATV due to the associated increase in the unsprung mass involved.

Thus, the only solution is a powerful but small electric motor for driving the front wheel which, however, because of the drive torque needed, requires a high electric drive capacity.

On the basis of the above, the object of the present invention is to make available a vehicle, particularly a motorcycle or ATV featuring a powerful electric motor for driving at least one front wheel which, whilst being capable of furnishing the necessary electric drive for operating the electric motor has no negative effect on the handling dynamics of the vehicle due to a marked increase in the unsprung mass.

The invention now comprises the features as claimed in claim 1 to achieve this object, advantageous aspects thereof being described in the further claims.

The invention now provides a vehicle having at least one front wheel drivable by means of an electric motor and at least one drivable rear wheel as well as an internal combustion engine supplying the front wheel and rear wheel with drive energy, the internal combustion engine being coupled to a starter generator for starting the internal combustion engine and furnishing electrical drive energy for driving the front wheel. In this arrangement, the starter generator replaces the starter motor usually provided with the internal combustion engine and its gearing for starting the internal combustion engine so that by replacing the starter generator the cited components can now be eliminated. In addition to this, the starter generator is able to provide the electrical drive energy for driving the front wheel which a generator unit usually provided for operating the internal combustion engine cannot provide. The starter generator thus replaces, in addition to the starter, also the generator unit usually provided. The starter generator provided in this case can be integrated without having to modify the housing of the internal combustion engine and is capable of delivering sufficient electric power to drive the electric motor of the front wheel.

To now make available the electrical drive energy needed to operate the high-power electric motor of the front wheel not via high amperages, it is provided for in accordance with one further embodiment of the invention that the vehicle has a first vehicle electric circuit having a first voltage for supplying electric consumers different from the electric motor and a second vehicle electric circuit having a second higher voltage for supplying the electric motor with electrical energy, the voltages being made available by means of the starter generator. This enables the second vehicle electric circuit, which can be operated with an electric voltage which is significantly higher than the first electric voltage of the first vehicle electric circuit, to contribute towards configuring the components needed to drive the front wheel more powerful but small dimensioned, since due to the significantly higher voltage of the second vehicle electric circuit it is possible to maintain the amperage needed to provide the necessary driving power of the front wheel drive low. This, on the one hand attains a high energy density of the electromotive drive of the front wheel and, on the other, permits the use of a small electric machine as regards the active mass of the front wheel drive because of the significantly higher voltage of, for example, up to 160 V in the second vehicle electric circuit as compared to the vehicle voltage of, for example, 12 to 14 V existing in the first vehicle electric circuit.

This results in a reduction in size of the electric machine comprising an otherwise equal electric power with a lower voltage reducing the masses existing in the region of the front wheel of the vehicle and thus, despite a powerful drive in the front wheel to no deterioration in the dynamic response in handling the vehicle equipped as such.

In accordance with another further embodiment of the invention the electric motor may be a wheel hub motor featuring a stator non-rotatably connected to a wheel axle and a rotor rotatably mounted on the wheel axle, the rotor of which ultimately powers rotation of the front wheel.

So that, despite a volumetrically smaller sized electric machine at the front wheel, it is assured that a high drive torque is made available at the front wheel, it is provided for in accordance with another further embodiment of the invention that between the front wheel and the rotor a gearing is provided and the rotor and front wheel having in addition opposing directions of rotation. With the gearing disposed in accordance with the invention between the front wheel and the rotor a small, high-speed electric machine can be made use of, whose output torque can now be significantly increased by the change in the translation ratio by the gearing between the rotor and the front wheel as compared to the torque existing at the output of the rotor. The gearing now also makes it possible that the rotor and the front wheel having opposing directions of rotation so that due to the high speed of the rotor the front wheel is not exposed to a high rotational moment of inertia which would retard the dynamic response in handling the vehicle when equipped as such.

As already explained above, it is provided for in accordance with the invention that the electric motor driving the front wheel is a wheel hub motor fully integrated within the hub of the front wheel rim. Explaining this in this way makes it clear that the space available to integrate the gearing in the hub is limited. To make use of this restricted space availability for integrating the gearing, it is now provided for in accordance with another further embodiment of the invention that the gearing is a planetary gear system with the addition of a freewheel between the front wheel and the wheel hub motor. The planetary gear system makes it possible to change the translation between the rotary speed of the rotor and the rotary speed of the wheel hub sufficiently large so that a drive torque of, for example, 250 Newton meters can be made available at the front wheel. So that, in case of the electric motor or gearing developing a fault, rotation of the front wheel can be continued, a freewheel is disposed between the front wheel and the wheel hub motor to ensure that even if the gearing were to be blocked, rotation of the front wheel is not detrimented.

To avoid high rotational moments of inertia which would be increased by a radial outwards mass distribution negatively influencing its dynamic response the front wheel of a motorcycle is usually dimensioned smaller than the rear wheel as viewed in the width direction of the rim, this also resulting in the front wheel having lower strength values than the rear wheel. So as to reliably transmit the high drive torque made available by the electric motor of the front wheel from the wheel hub to the rim, it is provided for in another further embodiment of the invention that the force between the electric motor and a rim of the front wheel is transmitted substantially as a tractive and/or thrusting force. In this arrangement, tractive transmission occurs when the electric motor actively drives the front wheel and thrust transmission can also occur when a braking action is instituted.

As already explained above it is provided for in the vehicle in accordance with the invention that two different vehicle electric circuits are used, namely a first vehicle electric circuit for powering the normally provided consumers such as for example the lighting and blinker, and a second vehicle electric circuit serving to power the electric motor. Since this involves high power density, as already explained, it is provided for in accordance with yet another further embodiment of the invention that the electric motor and/or the starter generator are fluid-cooled.

For this purpose the stator of the wheel hub motor may be provided with a circumferential arrangement of coolant passages and the passages closed off from the outside by means of a sleeve-shaped member provided with seals and the stator connected to a coolant circuit. In this arrangement the coolant circuit may be a separate coolant circuit or the stator may also be connected by its coolant to the cooling circuit for the internal combustion engine. To provide a flow of coolant through the stator it is provided for in accordance with a further embodiment of the invention that the stator is provided in the radially inboard portion with an inlet and an outlet for the coolant. The wheel hub motor provided in accordance with the invention is configured as an external rotor motor arranged within the wheel hub of the front wheel and extending by its outer diameter into the region of the inner diameter of the wheel hub so that the space made available by the wheel hub is filled out almost totally by the rotor.

So that the torque provided by the wheel hub motor can be picked off, it is provided for in yet another further embodiment of the invention that the rotor of the wheel hub motor is configured pot-shaped and comprises a boss at which a gearwheel is definable axially and non-rotatably meshing with planet wheels of a planetary gear system rotatably mounted on a common web and meshing with an annulus of the planetary gear system and the annulus being rotatably mounted on the wheel hub. In this way the rotation of the rotor is converted into an opposing rotation of the wheel hub with a corresponding increase in the output torque of the rotor as can be picked off at the wheel hub.

The internal combustion engine of the vehicle in accordance with the invention may drive the rear wheel directly or also indirectly by the starter generator providing electrical drive energy also for a rear wheel of the vehicle drivable by means of an electric motor. This now makes it possible for the vehicle in accordance with the invention to be driven at the front wheel or also at the rear wheel by means of separate electric motors. To take into account the high electrical energy density as aforementioned, it is also provided for in accordance with another further embodiment of the invention that the starter generator is directly coupled to a crankshaft of the internal combustion engine and features a rotor rotatable about an inboard stator comprising at least one coolant passage for the coolant flow so that also the starter generator can be configured fluid cooled in addition to the electric drive motor provided in the region of the wheel hub of the front wheel and also of a wheel hub of rear wheel where provided for.

As already explained above, the vehicle in accordance with the invention may be, for example, a motorcycle or an ATV each engineered for negotiating difficult terrain. On such a vehicle the internal combustion engine is often a four-stroke single-cylinder engine having a capacity exceeding 250 ccm, particularly exceeding 500 ccm and working with a compression radio of more than 10:1. Such an internal combustion engine is characterized in that it requires for starting a high starting torque of, for example, 50 Newton meters and a starting speed exceeding 1,000 rpm. Since the rotation angle position of the crank assembly of the internal combustion engine when stationary may differ, depending on in which rotation angle position the crank assembly was left standing since the last rotation of the internal combustion engine, the situation may occur in which starting is initiated with the starter generator in such a rotation angle position that the piston of the internal combustion engine is directly before top-dead center (TDC) at which ignition would occur. In this range the starting torque required of the starter generator to start the internal combustion engine is a maximum.

To make use of a smaller and weaker starter generator for reasons of reducing the weight, it is provided for in accordance with still a further embodiment of the invention that the starter generator actuates a crank assembly of the internal combustion engine before starting thereof into rotation into a rotation angle position remote from top-dead center (TDC) contrary to the direction of rotation of the crank assembly during operation of the internal combustion engine as specified and to then accelerate the crank assembly in the direction of rotation. This results in the starter generator first returning the crank assembly, for example, contrary to the direction of rotation of the internal combustion engine before then reversing the direction of rotation and to accelerate the crank assembly again in the direction of rotation of the internal combustion engine, in making use of the momentum of the crank assembly to start the internal combustion engine so that the starter generator can be designed smaller and thus weaker than would normally be necessary to reliably make available the starting torque needed to pass through TDC.

The electrical drive energy required by the electric motor of the front wheel depends, for example, on the mode in which the electric motor is operated, for instance in an operating mode in which the electric motor furnishes its maximum drive torque, or in an operating mode in which the drive torque is less than the maximum possible nominal torque.

To thus be able to supply the electric motor in every operating mode with sufficient electrical drive energy it is provided for in another further embodiment of the invention that the vehicle comprises an electrical energy storage system for receiving electrical energy from the starter generator, this system being configured to supply at least one electric motor for driving the front wheel of the vehicle with electrical drive energy and which is also capable of providing electrical drive energy to start the internal combustion engine by means of the starter generator.

The electrical energy storage system serves, on the one hand, as a buffer for adequate electrical drive energy for the electric motor and, on the other, also serving to supply the starter generator with electrical drive energy during starting of the internal combustion engine.

So that now both when starting the internal combustion engine as well as when operating the electric motor of the front wheel the amperage required of the vehicle electric circuit is not excessive, it is provided for in accordance with still another further embodiment of the invention that the electrical energy storage system is integrated in the circuitry of the vehicle electric circuit having a voltage exceeding 60 V and that a capacitor may be included in the vehicle electric circuit to cover any further peak loads. The high voltages exceeding for example 60 V, even exceeding 100 V in one aspect in accordance with the invention and, for example, up to 160 V in the second vehicle electric circuit being possible, now make it possible to reduce the amperage required to furnish the necessary output torque by the electric motor in the front wheel as compared to a lower voltage vehicle electric circuit.

In accordance with yet a further embodiment of the invention it is provided for that the electric motor of the front wheel can be operated in several different operating modes, it thus being provided, for example, that the electric motor drives the front wheel speed-controlled with such rotary speed control that the rotary speed of the front wheel follows a leading rotary speed of the rear wheel. When, for instance, the rotary speed of the rear wheel increases because of slip, this can be detected by means of a sensor and the electric motor consequently activated so that the rotary speed of the front wheel follows the rotary speed of the rear wheel in thus enabling the slip of the rear wheel to be diminished very quickly. In accordance with still another further embodiment of the invention, however, it is also provided for that the electric motor drives the front wheel torque-controlled such that front wheel is driven as a function of a driving resistance occurring at the front wheel irrespective of the operating condition of the rear wheel. This enables, for example, the torque capable of being furnished by the electric motor as a maximum to be made available when there is a sudden increase in the resistance to front wheel drive, for example, as may be the case when the front wheel hits a bump in the terrain or comes up against some other obstacle crossing its path, for instance. Irrespective of the rotary speed of the rear wheel the torque made available as a maximum by the front wheel hub motor in such a condition can be output and corresponding electrical drive energy obtained for this purpose from the electrical energy storage system. After the obstacle or sudden arrest condition has been overcome a change can be made manually or automatically back to the rotary speed controlled operating mode.

For this purpose the vehicle can comprise a system for controlling the torque output by the electric motor as a function of selectable or sensor-detected operating conditions of the vehicle. These selectable operating conditions may be dictated by the rider of the vehicle or selected from a multitude of control truth tables memorized in the control system. In this arrangement the controller may be arranged on insulated metal substrate (IMS) circuit boards as may also be configured, for example, on fluid-cooled motherboards which in turn can be correspondingly cooled in this way.

In addition to the rider being able to influence the operation of the electric motor manually, it is also provided for in accordance with the invention, however, that the control system evaluates the operating conditions as established by sensors, for example, for automatic activation of the electric motor of the front wheel as is also selectable by the rider of the vehicle. This now makes it possible for the rider of the vehicle in accordance with the invention to fully concentrate on the actual vehicle handling requirement whilst the control system provides open or closed loop control of the momentary torque output by the electric motor of the front wheel as a function of the evaluated operating conditions.

The vehicle in accordance with the invention may be an off-road or off-road competition motorcycle so that the front wheel is a front wheel of a motorcycle mounted on a wheel axle rotatable between tubular members of the front wheel fork of the motorcycle. However, it may also be provided for in accordance with the invention that the front wheel is a front wheel of a vehicle having more than two wheels, particularly of an all-terrain vehicle (ATV).

In conclusion, the invention also provides a method for actuating a two-wheeled vehicle for propulsion by means of an electric motor driving the front wheel and an internal combustion engine and/or an electric motor driving the rear wheel, the electrical drive energy for driving the at least one electric motor being taken from a vehicle electric circuit fed by means of a starter generator driven by the internal combustion engine and/or from the starter generator. It is thus also provided for in accordance with the invention that the drive energy needed to drive the electric drive motor of the front wheel can either be taken from the starter generator directly during operation of the internal combustion engine and/or from an energy storage within the vehicle electric circuit which is in turn fed by the starter generator.

The invention will now be detailed with reference to the drawing in which:

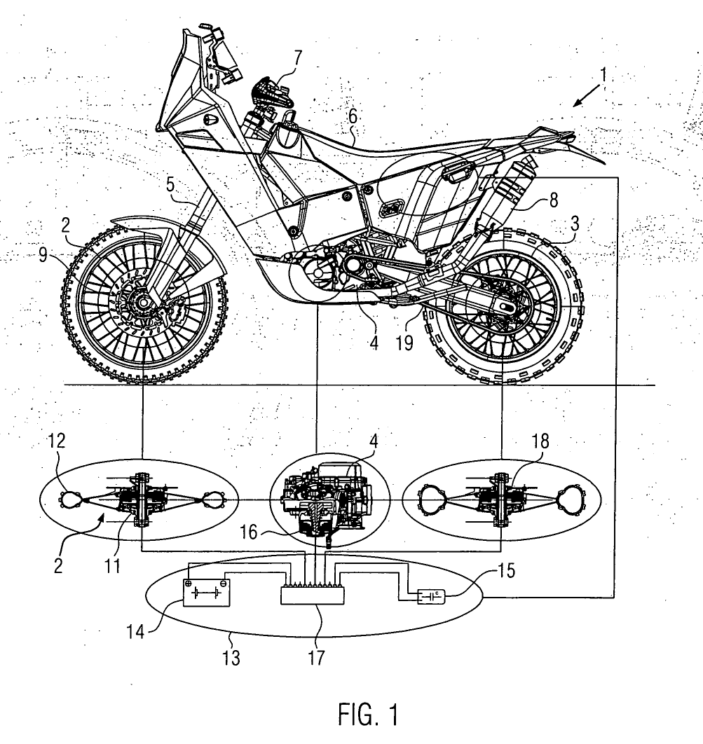

FIG. 1 is a side view of a motorcycle configured in accordance with the invention having an electric motor as the front wheel drive and an electric motor as the rear wheel drive, and an internal combustion engine as well as an energy supply system and a controller;

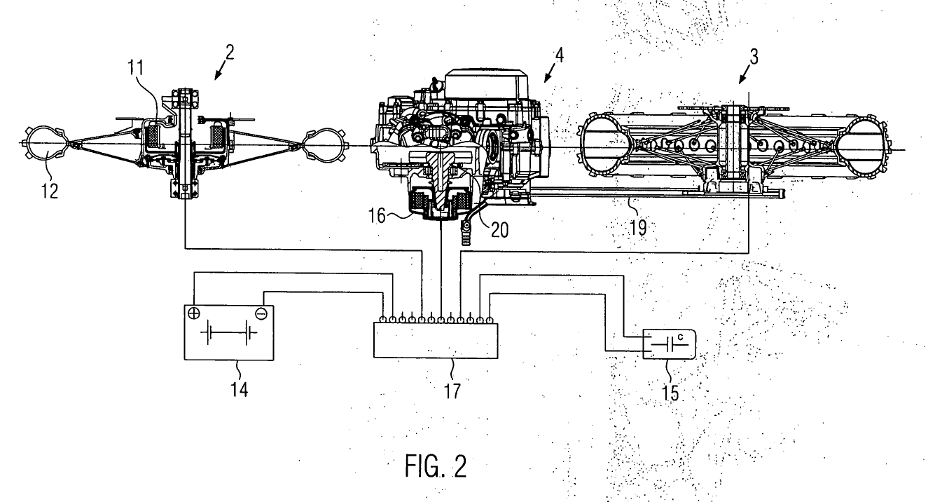

FIG. 2 is a diagrammatic illustration of the drive system including an electric motor for driving the front wheel, an internal combustion engine mechanically driving the rear wheel, and an energy supply system as well as a controller;

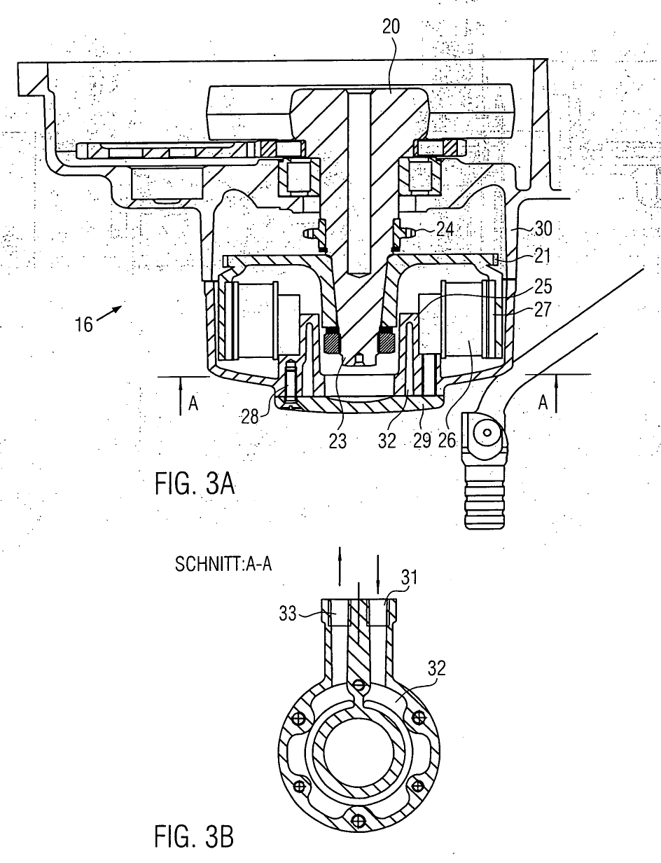

FIG. 3A is a sectioned view through a starter generator provided on the vehicle in accordance with the invention;

FIG. 3B is a top-down sectioned view showing a section through a stator featuring coolant passages of the starter generator as shown in FIG. 3A;

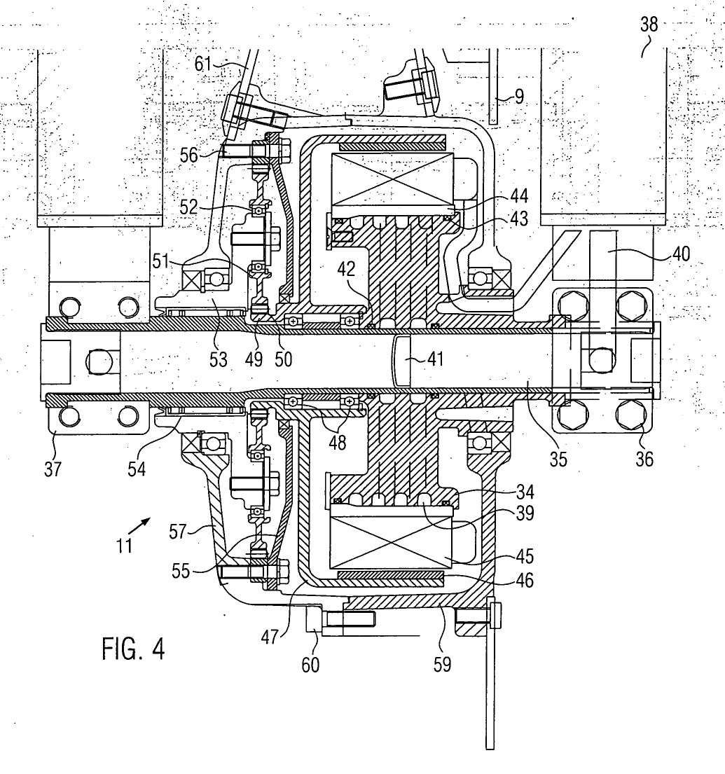

FIG. 4 is a partly sectioned view of a wheel hub motor driving the front wheel; and

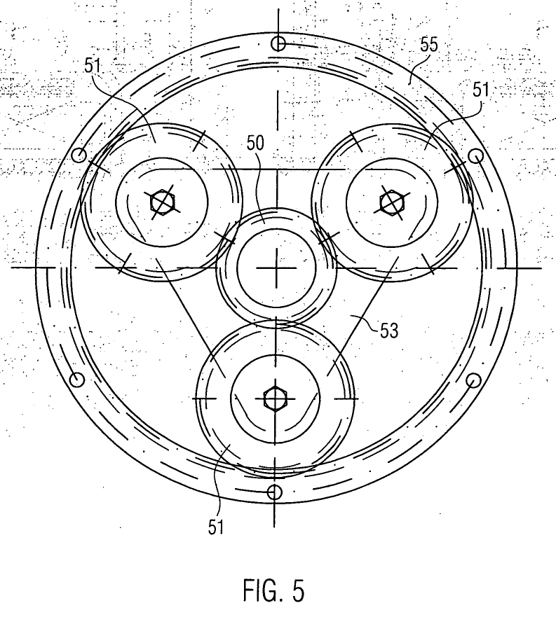

FIG. 5 is a top-down view of a planetary gear system disposed between the wheel hub and the rotor of the wheel hub motor.

Referring now to FIG. 1 of the drawing there is illustrated in a side view a motorcycle 1, particularly an off-road competition motorcycle having a front wheel 2, a rear wheel 3 and an internal combustion engine 4. In addition, the motorcycle 1 in accordance with the invention also includes further components such as, for example, a front wheel fork 5, a seat bench 6, handlebars 7 as well as an exhaust system 8 and components (not shown) such as for example a motorcycle frame serving to mount the internal combustion engine 4.

Located in the front wheel 2 is a brake disk 9 which, as shown, covers a wheel hub 10 comprising a wheel hub motor 11 further detailed in the following.

Depicted separately diagrammatically in the lower half of FIG. 1 are a few assemblies of the motorcycle 1 as will be detailed in the following.

The front wheel 2 comprises at the outer circumference a coarse-cleated tyre 12 as required for the particular application of the motorcycle 1 which, for example, may be of the tubeless type in ultimately serving to transfer the force from the front wheel 2 to the surface being negotiated by the motorcycle. The front wheel 2 features in addition a wheel hub motor 11 connected to the wheel hub 10 for power transmission, the wheel hub motor 11 including an electric motor for driving the front wheel 2. The electrical drive energy needed to drive the electric motor can be taken from an energy storage system 13 which may comprise a battery 14 and a capacitor 15 which is not a mandatory requirement, but which may be provided to buffer peak loads.

The battery 14 of the energy storage system 13 is fed by means of a starter generator 16 actuated by the internal combustion engine 4, the electrical drive energy required by the wheel hub motor 11 also being able to be supplied thereto directly by the starter generator 16. The starter generator 16 also serves as the electric motor starter for the internal combustion engine 4, the electrical drive energy required for this purpose for starting the internal combustion engine 4 being made available in turn by the battery 14. Via a controller 17 the wheel hub motor 11 is fed with the electrical drive energy as needed for the particular application and the controller 17 is also provided for to control two vehicle electric circuits provided on the motorcycle 1, namely a first vehicle electric circuit for a low voltage of, for example, 12 to 14 V serving to power such motorcycle electric consumers as, for example, the lighting, optical and acoustical signalling, powering a fuel pump for, where provided, an injector system of the internal combustion engine 4 and the like, and a second vehicle electric circuit for a significantly higher vehicle voltage exceeding, for example, 24 V, particularly exceeding 60 V and for example even exceeding 100 V up to particularly 160 V, this second vehicle electric circuit enabling the starter generator 16 to be loaded when starting the internal combustion engine 4, it also being capable of supplying the wheel hub motor 11 with the vehicle voltage needed for its operation.

In the embodiment as shown in FIG. 1 of the drawing the rear wheel 3 too, is loaded via a wheel hub motor 18 which likewise is powered by the electrical drive energy from the energy storage system 13. The motorcycle 1 as depicted in FIG. 1 also shows, however, a drive chain 19 serving to transmit the power from the internal combustion engine 4 to the rear wheel 3 when the rear wheel 3 is not loaded by a wheel hub 10, but instead is directly powered by the internal combustion engine 4 via the drive chain 19, this configuration then corresponding to the modified embodiment as shown in FIG. 2 of the drawing.

Referring now to FIG. 2 of the drawing there is illustrated detailed how the components serving to power the motorcycle in the form of the electric motor for the front wheel drive and the internal combustion engine 4 with the rear wheel 3 directly actuated thereby may be likewise provided on the motorcycle 1 instead of the units as shown in the lower half of FIG. 1. A motorcycle configured as such then features an electric front wheel drive and the rear wheel directly powered by the internal combustion engine, in such an embodiment too, a starter generator 16 being provided to start the internal combustion engine and to supply the two vehicle electric circuits with electrical drive energy.

In such a configuration too, the starter generator 16 serves to start the internal combustion engine 4 and to charge the energy storage system 13 or to supply the electromotive drive of the front wheel 2 with electrical drive energy.

Shown in detail in FIG. 2 of the drawing is a front wheel 2 with a wheel hub motor 11 which can be supplied with electrical drive energy via the battery 14 connected to the controller 17 and/or directly from the starter generator 16 to power the front wheel 2. FIG. 2 of the drawing also shows how a capacitor 15 may be provided, but not as a necessity, to cover peak loads.

The starter generator 16 is directly coupled to a crankshaft stub 20 of the internal combustion engine 4 in serving, on the one hand, to start the internal combustion engine 4 from standstill and, on the other, to provide the electrical drive energy for the wheel hub motor 11 and to supply the battery 14 and capacitor 15 with electrical energy. The rear wheel 3 in the embodiment as shown in FIG. 2 is loaded via a drive chain 19 directly by the internal combustion engine 4 so that the motorcycle configured as such features a rear wheel drive actuated via the internal combustion engine 4 and a front wheel drive furnished via the wheel hub motor 11.

Via the controller 17 the wheel hub motor 11 is supplied with the electrical drive energy as needed for each operating mode of the motorcycle, it thus being possible, for example, to operate the wheel hub motor 11 in the front wheel 2 rotary speed controlled. For this purpose a sensor can be fitted to the rear wheel 3 to sense the rotary speed of the rear wheel 3, it being the task of the controller 17 to ensure by correspondingly activating the wheel hub motor 11, the latter attempts to adapt the rotary speed of the front wheel 2 to the rotary speed of the rear wheel 3 as best possible. In other words, when a sensor detects a significant increase in rotary speed at the rear wheel 3 during a predetermined time interval, indicating, for example, slip of the rear wheel 3, then via the controller 17 electrical drive energy is supplied to the wheel hub motor 11 from energy storage system 13, the battery 14 and/or starter generator 16 such that the rotary speed of the front wheel 2 increases. This results in the slip of the rear wheel 3 being reduced in achieving a substantially better acceleration of the motorcycle 1 by the enhanced traction of both wheels. In this arrangement, however, only as much electrical drive energy is made available to the wheel hub motor 11 as is necessary to compensate the difference in the rotary speed of the rear wheel 3 to that of the front wheel 2. The energy storage system 13 may be, for example, a battery pack with a voltage of 150 V and both vehicle voltages can be branched off therefrom via a DC-to-DC converter.

However, the wheel hub motor 11 may also be activated so that the rotary speed of the front wheel 2 is slightly higher than that of the rear wheel 3. The drive energy needed to make the compensation of the rotary speed at the front wheel 2 must not correspond to that as made available when the wheel hub motor 11 has a maximum power output, instead a lesser power than that of the maximum may already be sufficient to deplete the slip of the rear wheel 3.

However, in addition to this mode of operating the wheel hub motor 11 with controlled rotary speed, controlling the torque may come into consideration when, namely, the motorcycle 1 is negotiating difficult terrain, requiring it to overcome a bump or some other transverse obstacle in the terrain or under conditions usually resulting in the motorcycle becoming bogged down, such as, for example, in a swampy terrain or soft sand or the like. In such a case the rider of the vehicle can switch the mode of operation of the torque control either manually or also as automatically selected via the controller 17 as a function of the operating conditions of the motorcycle as detected by means of sensors and evaluated as such, so that the torque output by the front wheel hub motor is a maximum irrespective of the rotary speed of the rear wheel. When this happens, the drain on the energy storage system 13, for example, may be quite considerable. On completion of the torque control mode, for instance after having overcome a standstill or as negotiated manually by the rider in the vehicle, a change can be made back to the speed control mode.

It is also possible by linking performance parameters or operating conditions of the vehicle, such as, for example, the driving speed, the rotary speed of the rear wheel, the steering angle, or by a sensor for detecting the climb of the terrain or the like to select a truth table from a possible multitude thereof for operating the wheel hub motor 11, the controller 17 then assuring that the electric front wheel drive is operated in an automatic mode. In this arrangement the possible modes of operation are automatically enabled and disabled by the controller allowing the rider of the vehicle to fully concentrate on handling the motorcycle.

To be able to handle the high electrical energy density existing in the drive system of the motorcycle 1 in accordance with the invention—which (not shown) may be a four wheel all-terrain vehicle—the controller 17 may be mounted for example on insulated metal substrate (IMS) circuit boards, configured in turn on a fluid-cooled motherboard.

It is thus also provided for to configure the starter generator 16 fluid-cooled to handle the aforementioned high electrical energy density involving the said high voltages in the vehicle electric circuit.

Referring now to FIG. 3A there is illustrated in a sectioned view how the starter generator 16 comprises a rotor 21 non-rotatably connected to the crankshaft 20 and releasably secured to a crankshaft stub 23 by means of a nut 22. A sprocket 24 arranged at the crankshaft stub 23 serves to mount a drive chain (not shown) for activating the valve gear components in the cylinder head of the internal combustion engine 4.

Provided at a stator 25 of the starter generator 16 radially outboard are inductors 26 with windings cooperating with permanent magnets 27 located radially inboard at the rotor 21.

The stator 25 can be releasably secured by bolts 28 to a cover 29 which may be, for example, an ignition cap so that by securing the cover 29 by fasteners (not shown) in the form of, for example, bolts or the like at the engine housing 30 the starter generator 16 can be releasably secured to the internal combustion engine 4.

Referring now to FIG. 3B of the drawing there is illustrated a view taken as the section A-A through FIG. 3A of the drawing. Via an inlet 31 a coolant can access the portion of the coolant passages 32 configured in the stator 25 to totally envelope the stator in the flow so that the starter generator 16 can be configured fluid-cooled corresponding to the high electrical energy density. The coolant flowing through the starter generator 16 can thus be guided in a separate circuit through a heat exchanger or also integrated in the coolant circuit for the internal combustion engine 4.

Referring now to FIG. 4 of the drawing there is illustrated in a partly sectioned view a wheel hub motor 11 for driving the front wheel 2.

The wheel hub motor 11 comprises a stator 34 formed by means of laminations located at a wheel axle 35. The wheel axle 35 is releasably located by means of two clamp mounts 36, 37 at the lower ends of stanchion tubes 38 of the front wheel fork 5. The stator 34 comprises in its radially external portion a spiral circumferential coolant passage 39 serving to cool the wheel hub motor 11.

The coolant in this arrangement is guided by a coolant conduit 40 depicted merely diagrammatically at the right-hand tube 38 into the portion of the wheel axle 35. The wheel axle 35 comprises a hollow bore and features a full-length passage via which the coolant can be guided into and then out of the coolant passage 39 of the stator. For this purpose the passage of the wheel axle 35 may be closed off roughly in the region of its longitudinal centerline with a plug 41 so that coolant entering the wheel axle 35 via a transverse port flows up to the plug 41, gaining access from there via a passage (not shown) to the coolant passage 39. The coolant than flows along the coolant passage 39 in a spiral flow enveloping the stator 34 up to a further passage (not shown) in the wheel axle 35 located in the vicinity of the plug 41, it then passing therethrough into the passage of the wheel axle 35 to be then communicated from there via a coolant conduit (not shown) as may be guided, for example, by the tube on the left opposite the stanchion tube 38 on the right into a separate heat exchanger or the heat exchanger of the internal combustion engine 4.

The coolant passage 39 is sealed off in the radially inboard portion and in the rotor portion by seals 42, 43 in each case, i.e. inboard relative to the wheel axle 35 and outboard relative to the a sleeve-shaped member 44.

The stator comprises a radial external winding 45 arranged radially inboard located at a pot-shaped rotor 47 rotatable by rolling contact bearings 48 relative to the wheel axle 35. The winding 45 is electrically powered by a conductor depicted merely diagrammatically and guided via a radially inboard free cut at the stator 34. The pot-shaped rotor 47 features a boss 49 machined with a toothing 50. This toothing 50 meshes with planet wheels 51 rotatably mounted by a mount 52 on a common web 53 mounted at the wheel axle 35 by a freewheel 54.

Referring now to FIG. 5 of the drawing there is illustrated in more detail how the planet wheels 51 mesh with an annulus 55 which is secured by bolts 56 to a wheel hub half 57. It is in this way that rotation of the rotor 47 relative to the stator 34—by means of the translation ratio of the planetary gear system 58 comprising the planet wheels 51, the web 53 and the annulus 55 between the rotary speed of the wheel hub motor 11 formed by the wheel hub half 57 and a second wheel hub half 59—results in rotation of the wheel hub motor 11 relative to the stator 34 in thus enabling the torque output by the wheel hub motor 11 to be considerably increased. In the present case the wheel hub motor 11 can make available an output torque of roughly 50 to 70 Newton meters so that due to the translation ratio of the planetary gear system of roughly 1:3.66 at the front wheel 2 a drive torque of roughly 183 to 256 Newton meters is made available. The controller 17 controls the wheel hub motor 11 so that even at low wheel speeds—or when the front wheel 2 is at a standstill—a high drive torque is made available at the front wheel 2. In one modified embodiment the planetary gear system can also be engineered to provide a translation ratio of roughly 1:2 to roughly 1:4.

The controller 17 can thus ensure that as of a predetermined rotary speed of the wheel hub motor 11 of, for example, roughly 2700 to 2800 rpm the drive by the wheel hub motor 11 is disabled, since this already corresponds to a relatively high driving speed of the motorcycle fitted as such, calling for no further propulsion by the front wheel 2. It is, of course, understood that other design criteria may override so that it is also possible to provide propulsion of the front wheel 2 from standstill to top speed of the motorcycle by the wheel hub motor 11.

The output power of the wheel hub motor 11 received by the two wheel hub halves 57 and 59 secured to the wheel hub 10 by means of a bolted connection 60 is then communicated via spokes 61 (shown merely diagrammatically) to the rim and tyre 12 of the front wheel 2.

The vehicle provided in accordance with the invention is characterized in that any slip caused by the front wheel drive can be instantly compensated at the rear wheel. In addition, by employing the starter generator at the internal combustion engine a reduction in weight is achieved by eliminating the starter as is normally provided and the generator, likewise normally provided. Due to the vehicle electric circuit working at a high voltage for powering the electric drive motor of the front wheel the wheel hub motor provided in this case can now be engineered exceptionally small and compact, enabling small wiring cross-sections with flexible wires to be used without any considerably increase in unsprung masses in the front wheel, as can be enhanced by a suitable material selection in the region of the wheel hub and for the individual components of the wheel hub motor. The planetary gear system disposed between the rotor of the wheel hub motor and the wheel hub in addition ensures that the front wheel and the rotor rotate opposingly so that there is no positive addition by overlapping of the rotational moments of inertia of the front wheel and of the rotor of the wheel hub motor.

The internal combustion engine may be selected as a two-stroke, four-stroke or also Wankel engine. Although in the embodiment as described above the starter generator is said to be directly mounted on the crankshaft of the single-cylinder four-stroke engine, it may also be connected to the crankshaft of the engine in a separate housing via, for example, a toothed belt, vee belt, roller or toothed chain or by means of a gear cascade or the like. The vehicle features an electrical energy storage system rendering the vehicle drive as a hybrid system, storing, on the one hand, the electrical drive energy furnished by the starter generator and, on the other, outputting the electrical drive energy to meet an added power requirement on starting and for the front wheel drive.

The controller ensures power distribution to the front wheel with closed or open loop control of the supply of the two vehicle electric circuits with electrical energy from the starter generator.

Where necessary, a capacitor may be provided in the energy storage system for outputting electrical energy when there is a peak power requirement.

In addition to the electric motor for the front wheel drive the drive system may also include an electric motor for the rear wheel drive or the rear wheel may be directly powered by the internal combustion engine by means of a chain or propeller shaft drive.

It is understood that express reference is made to the claims and the drawing as regards any features of the invention not detailed above.

### LIST OF REFERENCE SIGNS

1 motorcycle
2 front wheel
3 rear wheel
4 internal combustion engine
5 front wheel fork
6 seat bench
7 handlebars
8 exhaust system
9 brake disk
10 wheel hub
11 wheel hub motor
12 tyre
13 energy storage system
14 battery
15 capacitor
16 starter generator
17 controller
18 wheel hub motor
19 drive chain
20 crankshaft
21 rotor
22 nut
23 crankshaft stub
24 gearwheel
25 stator
26 inductor
27 permanent magnet
28 bolt
29 cover
30 engine housing
31 inlet
32 coolant passage
33 outlet
34 stator
35 wheel axle
36 clamp mount
37 clamp mount
38 stanchion tube
39 coolant passage
40 coolant conduit
41 plug
42 seal
43 seal
44 member
45 winding
46 permanent magnet
47 rotor of motor
48 rolling contact bearing
49 boss
50 toothing
51 planet wheels
52 mount
53 web
54 freewheel
55 annulus
56 bolt
57 wheel hub half
58 planetary gear system
59 wheel hub half
60 toothing
61 spokes

1. A vehicle having at least one front wheel (2) drivable by an electric motor and at least one drivable rear wheel (3) as well as an internal combustion engine (4) supplying the front wheel (2) and rear wheel (3) with drive energy, wherein the internal combustion engine (4) is coupled to a starter generator (16) for starting the internal combustion engine (4) and furnishing electrical drive energy for driving the front wheel (2).

2. The vehicle as set forth in claim 1, further comprising a first vehicle electric circuit having a first voltage for supplying electric consumers different from the electric motor and a second vehicle electric circuit having a second higher voltage for supplying the electric motor with electrical energy, the voltages being made available by means of the starter generator (16).

3. The vehicle as set forth in claim 1, wherein the electric motor is a wheel hub motor (11) comprising a stator (34) non-rotatably connected to a wheel axle (35) and a rotor (47) rotatably mounted on the wheel axle (35), the rotation of which drives the front wheel (2) in rotation.

4. The vehicle as set forth in claim 3, further comprising a gearing between the front wheel (2) and the rotor (47), and the rotor (47) and front wheel (2) have opposing directions of rotation.

5. The vehicle as set forth in claim 4, wherein the gearing is a planetary gear system (58) and further comprising a freewheel (54) between the front wheel (2) and the wheel hub motor (11).

6. The vehicle as set forth in claim 1, wherein the force between the electric motor and a rim of the front wheel (2) is transmitted substantially as a tractive and/or thrusting force.

7. The vehicle as set forth in claim 1, wherein either the electric motor or the starter generator (16) is fluid-cooled.

8. The vehicle as set forth in claim 7, wherein the stator (34) is provided with circumferentially arranged coolant passages (39) for receiving coolant liquid and the passages (39) are closed off from the outside by a sleeve-shaped member (44) provided with seals and the stator (25) being connectable to a coolant circuit.

9. The vehicle as set forth in claim 8, wherein the stator (35) comprises in a radially inboard portion an inlet and an outlet for the coolant.

10. The vehicle as set forth in claim 3 wherein the wheel hub motor (11) is as an external rotor motor arranged within the wheel hub (10) of the front wheel (2) and the outer diameter of the rotor (47) extends into the region of the inner diameter of the wheel hub (10).

11. The vehicle as set forth in claim 10, wherein the rotor (47) of the wheel hub motor (11) is pot-shaped and comprises a boss (49) at which a toothing (50) is meshable with planet wheels (51) of a planetary gear system (58) rotatably mounted on a common web (53) and meshing with an annulus (55) of the planetary gear system (58), and the annulus (55) being rotatably mounted on the wheel hub (10).

12. The vehicle as set forth in claim 1, wherein the starter generator (16) provides electrical drive energy for a rear wheel (3) of the vehicle drivable by means of an electric motor.

13. The vehicle as set forth in claim 12, wherein the starter generator (16) is directly coupled to a crankshaft (20) of the internal combustion engine (4), and features a rotor (21) rotatable about an inboard stator (25) comprising at least one coolant passage (32).

14. The vehicle as set forth in claim 1, wherein the starter generator (16) actuates a crank assembly of the internal combustion engine (4) before starting thereof into rotation into a shaft position remote from top-dead center contrary to the direction of rotation of the crank assembly during operation of the internal combustion engine (4), and to then accelerate the crank assembly in the direction of rotation.

15. The vehicle as set forth in claim 1, further comprising an electrical energy storage system (13) for receiving electrical energy from the starter generator (16), this system supplying at least one electric motor for driving the front wheel (2) with electrical drive energy, and the system providing electrical drive energy to start the internal combustion engine (4) by means of the starter generator (16).

16. The vehicle as set forth in claim 15, wherein the electrical energy storage system (13) is integrated in the circuitry of the vehicle, the circuitry having a voltage exceeding 60V, and the circuitry comprises a capacitor (15) to cover peak loads.

17. The vehicle as set forth in claim 1, wherein the electric motor drives the front wheel (2) with such rotary speed control that the rotary speed of the front wheel (2) follows a leading rotary speed of the rear wheel (3).

18. The vehicle as set forth in claim 17, wherein the electric motor drives the front wheel (2) in a torque-controlled manner such that the front wheel (2) is actuated depending on a driving resistance occurring at the front wheel (2) irrespective of the operating condition of the rear wheel (3).

19. The vehicle as set forth in claim 1, further comprising a control system (17) for controlling the torque output by the electric motor as a function of selectable or sensor-detected operating conditions of the vehicle.

20. The vehicle as set forth in claim 19, wherein the control system (17) evaluates the operating conditions for automatic activation of the electric motor of the front wheel (2) by a rider of the vehicle.

21. The vehicle as set forth in claim 1, wherein the front wheel is a front wheel (2) of a motorcycle (1) mounted on a wheel axle (35) rotatable between tubular members of a front wheel fork (5) of the motorcycle (1).

22. The vehicle as set forth in claim 1, wherein the front wheel is a front wheel of a vehicle having more than two wheels.

23. A method for actuating a two-wheeler vehicle for propulsion by means of an electric motor driving the front wheel (2) and an internal combustion engine (4) driving the rear wheel (3) or an electric motor, comprising the step of taking from a vehicle electric circuit fed by means of a starter generator (16) driven by the internal combustion engine (4) the electrical energy for driving the electric motor.
